(19) United States
(12) Patent Application Publication
(10) Pub. No.: US 2006/0043942 A1
(43) Pub. Date: Mar. 2, 2006

(54) Power converter apparatus and methods using output current feedforward control

(76) Inventor: Isaac Cohen, Dix Hills, NY (US)

Correspondence Address: MYERS BIGEL SIBLEY & SAJOVEC, PO BOX 37428, RALEIGH, NC, 27627, US

(21) Appl. No.: 11/236,201

(22) Filed: Sep. 27, 2005

Related U.S. Application Data
(63) Continuation-in-part of application No. 10/709,553, filed on May 13, 2004.
(60) Provisional application No. 60/594,933, filed on May 20, 2005.
(60) Provisional application No. 60/595,635, filed on Jul. 22, 2005.

(51) Int. Cl. G05F 1/70

(52) U.S. Cl. 323/207

(57) ABSTRACT

A controller for a boost converter includes a first current sense input configured to receive an inductor current sense signal representative of a current in the inductor and a second current sense input configured to receive an output current sense signal representative of an output current of the boost converter. The controller further includes a control circuit configured to be coupled to a boost switch of the boost converter and to control the boost switch responsive to the received inductor current sense signal to force an input current of the boost converter directly proportional to the output current and to an input voltage of the boost converter and inversely proportional to an output voltage of the boost converter. The invention may be embodied as apparatus or methods.

### RELATED APPLICATIONS

The present application is a continuation-in-part application of U.S. patent application Ser. No. 10/709,553 entitled “Method and Control Circuit for Power Factor Correction,” filed May 13, 2004, and claims the benefit of U.S. Provisional Application Ser. No. 60/594,933 entitled “Power Factor Correction Circuits for Wide Input Voltage Range,” filed May 20, 2005, and United States Provisional Application Ser. No. 60/595,635 entitled “Modulation Method for PFC Boost Converters,” filed Jul. 22, 2005, the disclosures of each of which are hereby incorporated by reference herein in their entireties.

### BACKGROUND OF THE INVENTION

The present invention relates to power electronics apparatus and methods and, more particularly, to power converter apparatus and methods.

Boost converters are used in a variety of applications. For example, in power supply applications, a boost converter may be used to generate a boosted DC voltage from an input AC or DC voltage. Control circuits for boost converters may be used to perform power factor correction as described, for example, in U.S. Pat. No. 5,867,379 to Maksimovic et al.

Conventional control circuits for boost converters may be classified into two categories: (1) control circuits with an explicit current waveform reference (e.g., based on average current mode control); and (2) control circuits without an explicit waveform reference. Both types of circuits commonly force the input current of the converter to be proportional to the instantaneous value of the input voltage and include a voltage feedback amplifier that amplifies a difference between the output voltage of the converter and a reference voltage and use the resulting error signal to adjust the amplitude of the input current in response to changes in the input voltage or the output current of the converter.

As the input current of such a converter is generally proportional to its input voltage, an increase in the input voltage will generally cause an increase in the input current, which may result in a large increase in the input power and the output voltage. A consequence of this property is that the voltage control loop gain generally varies as the square of the input voltage. This gain variation may have a detrimental effect on the stability and dynamic response of the control circuit.

In the case of conventional average current mode control, the input voltage (which typically is sensed to generate the input current reference) may be used to generate an input voltage feed forward signal that is used to reduce or eliminate the gain variation. Control circuits without an explicit current waveform reference typically do not require input voltage information, so adding circuitry for input voltage sensing to generate a gain correction signal tends to negate an advantage of these circuits by adding significant complexity that may render these circuits as complex as conventional average current mode control based circuits. In addition, because the bandwidth of the voltage control loop often is limited to a relatively low value due to harmonic distortion considerations, typical conventional boost converters often exhibit relatively poor load transient response characteristics.

### SUMMARY OF THE INVENTION

Some embodiments of the present invention arise from a realization that output current feed forward can be used in a boost converter to provide very fast load transient response and significantly reduce the amount of correction that has to be provided by the feedback loop. Furthermore, boost converter control circuits according to some embodiments of the present invention may generate an internal signal that is representative of input voltage without requiring direct sensing of input voltage. Such a signal may be used, for example, to adaptively adjust input current loop gain and/or to detect brownout or other input voltage conditions.

In some embodiments of the present invention, controllers may be provided for boost converters that include an inductor and a boost switch that control current conduction therefrom. Such a boost converter controller may include a first current sense input configured to receive an inductor current sense signal representative of a current in the inductor and a second current sense input configured to receive an output current sense signal representative of an output current of the boost converter. The controller may further include a control circuit configured to be coupled to the boost switch and to control the boost switch responsive to the received inductor current sense signal and the received output current sense signal to force an input current directly proportional to the output current and to an input voltage of the boost converter and inversely proportional to an output voltage of the boost converter. The first current sense input, the second current sense input and the control circuit may be, for example, implemented in an integrated circuit and configured to be coupled to an inductor current sensor, and output current sensor and the boost switch, respectively.

The control circuit may use current feedforward from the output current sense signal. The control circuit may be configured to provide open loop regulation of the output voltage with respect to the output current. The controller may further include a voltage sense input configured to receive an output voltage sense signal representative of the output voltage, and the control circuit may be further configured to control the boost switch responsive to the output voltage sense signal to, for example, adaptively modify the gain of an input current control loop. For example, the control circuit may be configured to generate a correction signal responsive to a comparison of the output voltage sense signal to a reference signal and to control the boost switch responsive to a product of the inductor current sense signal and the correction signal. In other embodiments, the control circuit may be configured to generate a correction signal responsive to a comparison of the output voltage sense signal to a reference signal and to control the boost switch responsive to a product of the output current sense signal and the correction signal. In this manner, adaptive correction of an input current control loop may be achieved.

According to further embodiments of the present invention, the control circuit may comprise a pulse-width modulation (PWM) circuit configured to control a duty cycle of the boost switch responsive to the inductor current sense signal and the output current sense signal. The PWM circuit may comprise a peak current mode control circuit, a valley current mode control circuit and/or a charge control circuit. In some embodiments, the PWM circuit may include a drive circuit that initiates conduction by the boost switch responsive to a clock signal and terminates conduction by the boost switch responsive to a comparator output signal, an integrator that periodically integrates the output current sense signal responsive to the clock signal to generate a sawtooth signal, and a comparator that compares a difference between the output current sense signal and the sawtooth signal to the inductor current sense signal to generate the comparator output signal. In further embodiments, the PWM circuit may include a drive circuit that initiates conduction by the boost switch responsive to a clock signal and terminates conduction by the boost switch responsive to a comparator output signal, an integrator that periodically integrates the output current sense signal responsive to the clock signal to generate a sawtooth signal, and a comparator that compares a sum of the inductor current sense signal and the sawtooth signal to the output current sense signal to generate the comparator output signal. In additional embodiments, the PWM circuit may include a drive circuit that initiates conduction by the boost switch responsive to a comparator output signal and terminates conduction by the boost switch responsive to a clock signal, an integrator that periodically integrates the output current sense signal responsive to the clock signal to generate a sawtooth signal, and a comparator that compares the sawtooth signal to the inductor current sense signal to generate the comparator output signal. In still further embodiments, the PWM circuit may include a drive circuit that initiates conduction by the boost switch responsive to a comparator output signal and terminates conduction by the boost switch responsive to a clock signal, an integrator that periodically integrates a sum of the output current sense signal and a stabilizing signal responsive to the clock signal to generate a sawtooth signal, a comparator that compares the sawtooth signal to a sum of the inductor current sense signal and the stabilizing signal to generate the comparator output signal.

According to additional embodiments of the present invention, a boost converter includes an input, an output, an inductor coupled to the input, a rectifier coupled to the inductor and the output and a boost switch that controls conduction from the inductor through the rectifier. The converter also includes an inductor current sensor configured to generate an inductor current sense signal representative of a current in the inductor and an output current sensor configured to generate an output current sense signal representative of an output current at the output. The converter further includes a control circuit configured to control the boost switch responsive to the inductor current sense signal and the output current sense signal to force an input current at the input directly proportional to the output current and to an input voltage at the input and inversely proportional to an output voltage at the output.

Further embodiments provide methods of operating a boost converter. An inductor current sense signal representative of a current in an inductor of the boost converter is generated. An output current sense signal representative of an output current of the boost converter is generated. A boost switch of the converter is controlled responsive to the inductor current sense signal and the output current sense signal to force the input current directly proportional to the output current and to an input voltage of the boost converter and inversely proportional to an output voltage of the boost converter.

### BRIEF DESCRIPTION OF THE DRAWINGS

FIG. 1 is a schematic diagram illustrating a boost converter according to some embodiments of the present invention.

FIGS. 2 and 3 are schematic diagrams illustrating boost converters with regulation responsive to output voltage according to some embodiments of the present invention.

FIGS. 4 and 5 are schematic diagrams illustrating boost converters with Peak Current Mode Control (PCMC) circuits according to some embodiments of the present invention.

FIGS. 6 and 7 are schematic diagrams illustrating boost converters with Valley Current Mode Control (VCMC) circuits according to some embodiments of the present invention.

FIG. 8 is a schematic diagram illustrating a boost converter with a Charge Control (CC) circuit according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “including” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

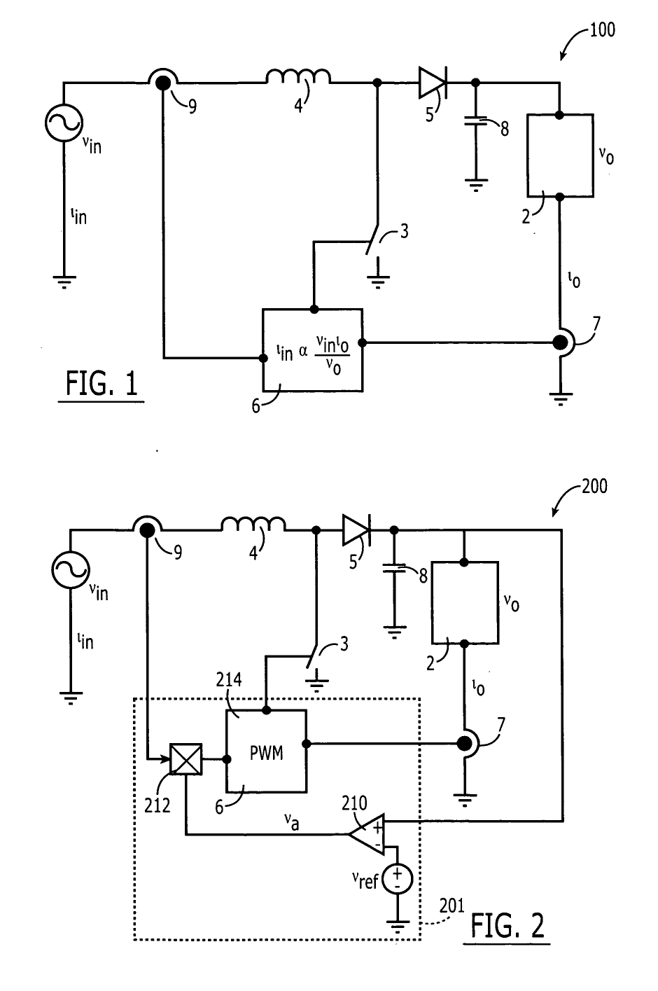

FIG. 1 illustrates a boost converter 100 and operations thereof according to some embodiments of the present invention. The converter 100 includes an inductor 4, a boost switch 3, a rectifier 5, an output filter capacitor 8, and a control circuit 6 that is configured to control the boost switch 3 responsive to an inductor current sense signal generated by an inductor current sensor 9 and an output current sense signal generated by an output current sensor 7. It will be appreciated that the inductor current sense signal and/or the output current sense signal may be filtered or otherwise processed. For example, in certain embodiments, the inductor current sense signal may be filtered to compensate for ripple in the inductor current.

The control circuit 6 (which may be a pulse width modulation (PWM) circuit) is configured to control the switch 3 to force the input current iₒ of the boost converter 100 directly proportional to the input voltage vᵢₙ, direct proportional to the output current iₒ and inversely proportional to the output voltage vₒ. It will be appreciated that the boost switch 3 may include any of a number of different types of switching devices, such as field effect transistors (FETs) or insulated gate bipolar transistors (IGBTs). The control circuit 6 may generally include analog circuitry, digital circuitry or combinations thereof.

According to some embodiments of the present invention, the control circuit 6 may implement a control law following the relationship:
iᵢₙ=K*vᵢₙ*iₒ/vₒ (1),
where K is a constant, vᵢₙ is the converter's input voltage, iᵢₙ is the input current, vₒ is the output voltage and iₒ is the output current delivered to a load 2. If the conversion efficiency is assumed to be 100%,
vᵢₙ*iᵢₙ=vₒ*iₒ (2).
Substituting Eq. (1) into Eq. (2):
vᵢₙ*K*vᵢₙ*iₒ/vₒ=vₒ*iₒ. (3)
If the output current is non-zero, Eq. (3) may be simplified to:
vₒ=vᵢₙ*(K)^{1/2} (4)

Eq. (4) indicates that the output voltage of the boost converter 100 can be maintained proportional to the input voltage and substantially independent of changes in the output current of the converter 100. Therefore, the output voltage vₒ can be set to a desired value proportional to the input voltage vᵢₙ by adjusting the value of the gain K. For the boost converter 100, the gain K is equal to or larger than unity. A DC/DC converter that generates an output voltage proportional to its input voltage and regulated with respect to load changes can be viewed as a “DC transformer.” Such a “DC transformer” may be useful in some applications but, in many cases, it may be desirable to also regulate the output voltage against input voltage changes.

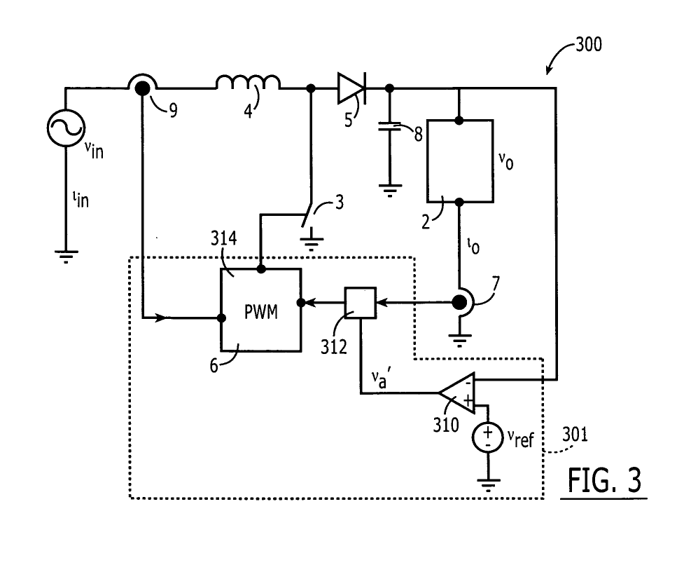

A boost converter 200 with output voltage regulation functionality according to further embodiments of the present invention is illustrated in FIG. 2. Like components of the boost converter 200 of FIG. 2 and the boost converter 100 of FIG. 1 are indicated by like reference numerals, and further discussion of these components will be omitted in light of the foregoing description of FIG. 1. The boost converter 200 includes a controller 201 comprising a voltage error amplifier 210, a multiplier 212 and a PWM control circuit 214. The amplifier 210 amplifies a difference between the output voltage vₒ of the converter and a reference voltage V_{ref} to produce an output voltage error signal vₐ. The multiplier 212 multiplies the inductor current sense signal produced by the inductor current sensor 9 by the output voltage error signal vₐ. The PWM control circuit 214 controls a duty cycle of the boost switch 3 responsive to an output current sense signal generated by the output current sensor 9 and the output of the multiplier 312. The control law implemented by the PWM control circuit 214 may be given by:
iᵢₙ*vₐ=vᵢₙ*K*iₒ/vₒ. (5)
Performing algebraic operations along the lines described above, the output voltage vₒ of the converter 200 may be given by:
vₒ=vᵢₙ*(K/vₐ)^{1/2}. (6)
In such a configuration, a change in the input voltage vᵢₙ of the converter will cause a difference to develop between the output voltage vₒ and the reference voltage V_{ref}. If the gain of amplifier 10 is sufficiently high, the amplifier output voltage vₐ will assume a value sufficient to substantially nullify the difference between the output voltage vₒ and the reference voltage V_{ref}. Referring to Eq. (6), this value will be inversely proportional to the square of the input voltage vᵢₙ. Accordingly, the signal vₐ can be constrained to be a function of the input voltage alone, e.g., in Eq (6), assuming the output voltage vₒ is maintained substantially constant, the value of the error voltage vₐ will generally be inversely proportional to the square of the input voltage vᵢₙ.

Generating such a signal that is a function of only the input voltage can be advantageous in many ways. As described above, this information can be useful for attenuating loop gain variation due to input voltage change. It can also eliminate the need to directly sense the input voltage. Information about input voltage may be useful for various purposes. For example, such information may be used to detect a “brownout” or other sustained low input voltage condition that could lead to sustained high input currents that result in overheating and damage of portions of the converter. It may be problematic to directly sense input voltage (e.g., in high voltage applications) and/or direct sensing of input voltage may require complex or expensive additional circuitry. Using input voltage information gained as described above can obviate these problems.

One possible way to attenuate loop gain variation is to square the error voltage vₐ produced by the error amplifier 210, thereby reducing the loop gain dependence on input voltage from square to linear. If the control circuit 214 is a PWM circuit, another way to attenuate the loop gain variation is to modulate the PWM clock frequency using the error signal vₐ of the error amplifier 210.

FIG. 3 illustrates a boost converter 300 according to further embodiments of the present invention, which represents an alternative implementation to that shown in FIG. 2. In the converter 300, a controller 301 includes an output voltage error amplifier 310 that has its polarity reversed in relation to the error amplifier 210 of FIG. 2, and the output current sense signal from the output current sensor 7 is multiplied in a multiplier 312 by the output voltage vₐ′ of the error amplifier 310. A PWM control circuit 314 provides control of a duty cycle of the boost switch 3 responsive to the output of the multiplier 312 and the inductor current sense signal produced by the inductor current sensor 9. In this implementation, loop gain change attenuation can be obtained by extracting the square root of the error signal vₐ prior to the multiplication by the output current sense signal.

PWM modulators that provide input current control according to some embodiments of the present invention can be embodied using a variety of different control techniques, including, but not limited to, variants of Peak Current Mode Control (PCMC), Valley Current Mode Control (VCMC) and Charge Control (CC) techniques. It will be appreciated that other modulator configurations fall within the scope of the invention.

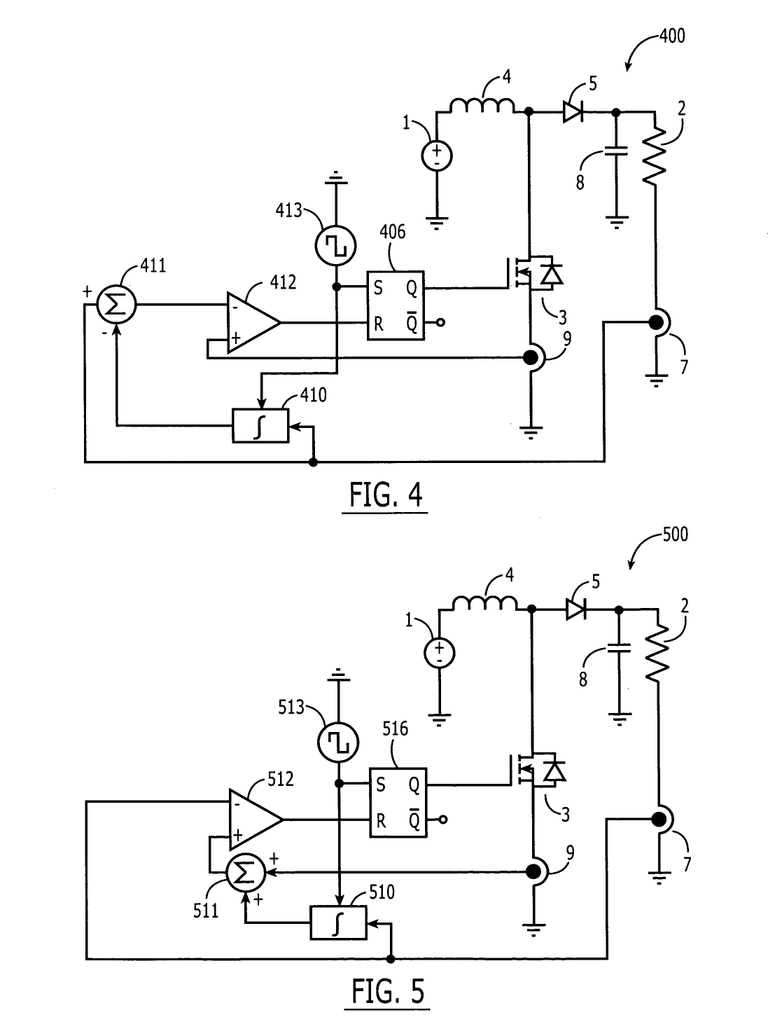

An example of a converter 400 with a PCMC derived modulator according to some embodiments of the present invention is shown in FIG. 4. The converter 400 includes an inductor 4, rectifier 5, output capacitor 8 and output and inductor current sensors 7, 9. The boost switch 3 is turned on when a pulse of a clock signal 413 sets a bi-stable switch drive circuit, here shown as an SR flip-flop 406. A subtractor 411 determines a difference between a current feed forward signal, here an output current sense signal generated by the output current sensor 7, and a compensating sawtooth signal generated by an integrator 410. The switch 3 is turned off when the SR flip-flop 406 is reset by a comparator 412 as the value of an inductor current sense signal generated by the inductor current sensor 9 becomes equal to the difference between the output current sense signal generated by the output current sensor 7 and the compensating sawtooth signal generated by an integrator 410. The integrator 410 integrates the output current sense signal to generate the compensating sawtooth signal, and is reset by the clock signal 413. Because the control circuitry shown in FIG. 4 does not need input current information during the “off” interval of the boost switch 3, the inductor current sensor 409 may be placed in series with either the boost switch 3 or the input of the converter 400.

In some cases, it may be more convenient to use the configuration shown in FIG. 5. The boost converter 500 of FIG. 5 includes an inductor 4, rectifier 5, output capacitor 8, boost switch 3 and output and inductor current sensors 7, 9. An integrator 510 generates a compensating sawtooth signal from the output current sense signal generated by the output current sensor 7. The compensating sawtooth signal is added by an adder 511 to the inductor current sense signal generated by an inductor current sensor 9 to generate a signal that is compared with the output current sense signal in a comparator 512. The output of the comparator 512 is used to reset an SR flip-flop 516 that controls the boost switch 3 in conjunction with a clock signal 513.

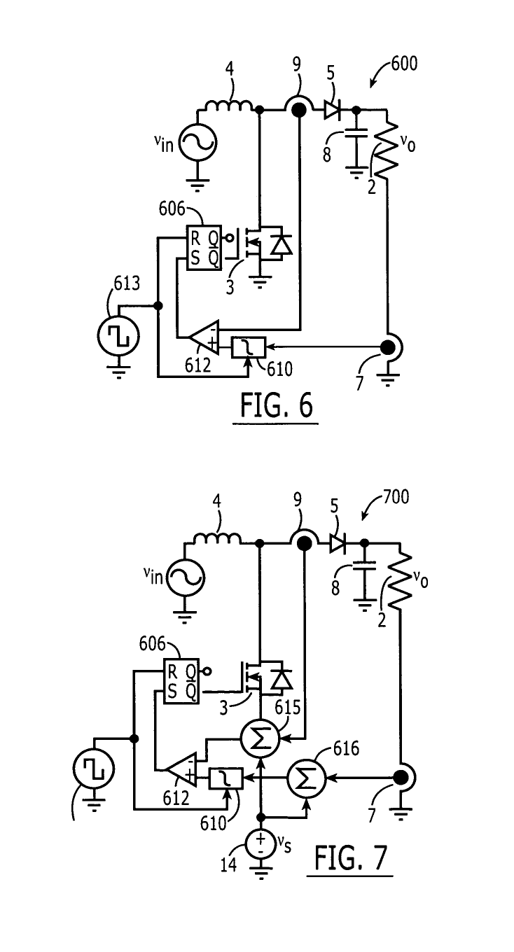

FIG. 6 illustrates a boost converter 600 using VCMC according to further embodiments of the present invention. The boost converter 600 includes an inductor 4, rectifier 5, output capacitor 8, boost switch 3, and output and inductor current sensors 7, 9. An integrator 610 integrates an output current feed forward signal in the form of an output current sense signal produced by the output current sensor 7, and is periodically reset by a clock signal 613, thereby generating a sawtooth waveform. The boost switch 3 is turned on by an SR flip-flop 606, which is set by a comparator 612 when the sawtooth signal generated by the integrator 610 exceeds an inductor current sense signal generated by the inductor current sensor 9. Pulses of the clock signal 613 terminate the conduction of the boost switch 3. The time interval during which the input current is relevant is the “off” interval of switch 3, so the inductor current sensor 9 may be installed in series with either the rectifier 5 or the input of the converter 600.

It is known that VCMC converters operating in the discontinuous mode at a duty cycle of less than 50% may develop sub-harmonic oscillations. These oscillations can be suppressed by summing a stabilizing DC voltage vₛ with the signals delivered to the input of integrator 610 and the inverting input of comparator 612 using summers 615, 616 as is done in the converter 700 shown in FIG. 7. Because such a stabilizing signal may cause a distortion of the current waveform, it is desirable to reduce its impact if the duty cycle exceeds 50%. This can be accomplished by making the stabilizing signal proportional to the input voltage or, for potentially better performance, to the square of the input voltage. The circuit shown can produce signals that are proportional to the input voltage and to the square of the input voltage so the desired proportionality can be obtained by multiplying the stabilizing DC voltage by one of these signals.

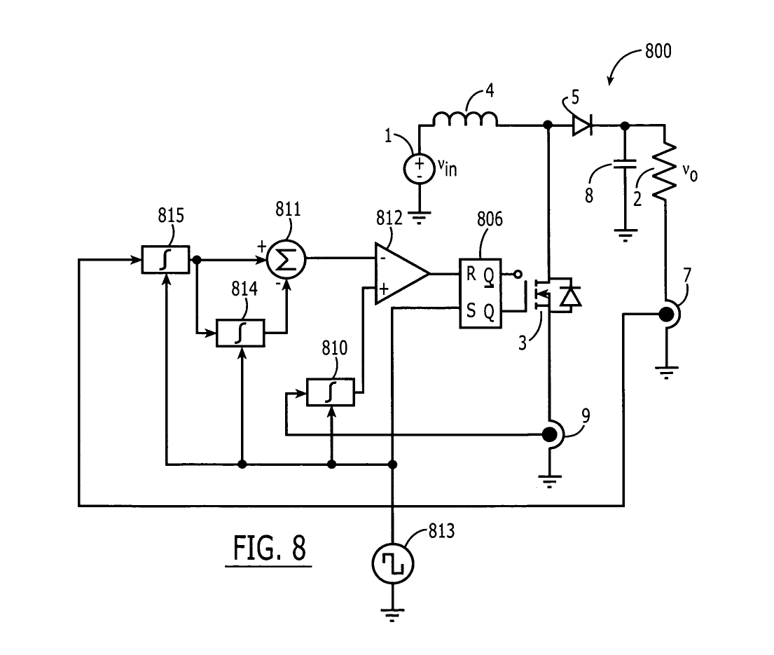

FIG. 8 illustrates a boost converter 800 using CC modulation according to further embodiments of the present invention. The converter 800 includes an inductor 5, rectifier 5, output capacitor 8, boost switch 3 and output and inductor current sensors 7, 9. In the converter 800, a clock signal 813 sets an SR flip-flop 806 and resets integrators 810, 814 and 815. The integrator 810 produces a signal proportional to the charge absorbed during the conduction of switch 3 from the input of the converter 800 by integrating the inductor current sense signal produced by the current sensor 9. This signal is applied to the non-inverting input of a comparator 812.

The integrator 815 integrates the output current sense signal produced by the output current sensor 7. The integrator 814 integrates the signal produced by the integrator 815, producing a signal that is subtracted from the signal produced by the integrator 815 in a subtractor 811. The resulting signal is applied to the inverting input of the comparator 812, which resets SR flip-flop 6 when the output of the integrator 810 exceeds the output of the subtractor 811. The inductor current sensor 9 may be in series with either switch 3 or the input of the converter 800.

A mathematical analysis of operations of the converters shown in FIGS. 4-8 will now be provided. It will be appreciated that the following analysis is provided for purposes of theoretical explanation and does not limit the scope of the invention to the mathematic models herein. In the analysis, the following symbols are used:

iᵢₙ=input current of the converter;

vᵢₙ=input voltage of the converter;

vₒ=output voltage of the converter;

iₒ=output current of the converter;

K=a proportionality constant;

T_{sw}=switching period of the converter; and

tₒₙ=conduction time of the boost switch.

Balancing of the volt-second product on the boost converter's inductor, T_{sw}, tₒₙ, vᵢₙ and vₒ may be related by:
tₒₙ=T_{sw}*(vₒ−vᵢₙ)/vₒ. (7)

For the PCMC modulator of FIGS. 4 and 5:
iᵢₙ/K=iₒ−K₁*iₒtₒₙ, (8)
where K₁ is the gain of the integrators 410, 510. Substituting Eq. (7) into Eq. (8) yields:
iᵢₙ/K=iₒ−K₁*iₒ*T_{sw}*(vₒ−vᵢₙ)/vₒ. (9)
If K₁=1/T_{sw}:
iᵢₙ=K*iₒvᵢₙ/vₒ, (10)
which conforms to Eq. (1).

For the VCMC converters of FIGS. 6 and 7:
iᵢₙ/K=K₁*iₒ*(T_{sw}−tₒₙ), (11)
where K₁ is the gain of the integrators 610. Substituting Eq. (7) into Eq. (11) yields:
ᵢₙ/K=K₁*iₒ*[T_{sw}−T_{sw}*(vₒ−vᵢₙ)/vₒ]. (12)
Setting K₁=1 yields:
iᵢₙ=T_{sw}*K*iₒ*vᵢₙ/vₒ. (13)
Eq. (13) reduces to Eq. (1) if the switching period (frequency) of the converter is kept constant. The dependence of the input current on the switching period of the converter presents the opportunity to attenuate the voltage loop gain variation by making the clock frequency proportional to the output voltage of the error amplifier.

The operation of the CC converter 800 of FIG. 8 may be described by the following:
K₁*iᵢₙ*tₒₙ/K=iₒ*K₂*tₒₙ*(1−K₃*tₒₙ), (14)
where K₁ is the gain of the integrator 810, K₂ is the gain of the integrator 815, and K₃ is the gain of the integrator 814. Substituting Eq. (7) into Eq. (14) and solving for iᵢₙ yields:
iᵢₙ=K*(T_{sw}*K₃*vᵢₙ−T_{sw}*K₃*vₒ+vₒ)*iₒ*K₂/(K₁*vₒ). (15)
Setting K₃=1/T_{sw} and K₁=K₂ yields:
iᵢₙ=K*vᵢₙ*iₒ/vₒ, (16)
which agrees with Eq. (1).

In some embodiments of the present invention, the inductance of an inductor of a boost converter may be relatively high and, consequently, ripple current may be relatively low, such that peak, average and instantaneous values of the inductor current may be nearly equal. If ripple current is sufficiently low, it may be possible to use any of these as the input current iₒ in the above analysis without undue distortion. If the peak-to-peak ripple is relatively high, however, the peak, valley and average values of the current may be significantly different. In such cases, depending on type of modulator used, it may be desirable to use either the peak or the valley current as the input current iₒ. The average input current of the converter may not be exactly proportional to the input voltage, resulting, for example, in harmonic distortions when circuits of the present invention are used in power factor correction applications. In order to reduce the error in average current, the signal representative of the input current may be filtered using, for example, a low pass filter. For example, in some embodiments, a low pass filter with a corner frequency of approximately one decade below the switching frequency of the converter may be applied to an inductor current sense signal as described above to attenuate the ripple without excessively affecting the bandwidth of the current control circuit. It will be appreciated that the present invention encompasses embodiments with or without such filtering.

It will be understood that each of the modulator configurations shown in FIGS. 4-8 may be modified to include an additional input voltage regulation capability along the lines described above with reference to FIGS. 2 and 3. For example, in each of the embodiments of FIGS. 4-8, an output voltage error signal may be determined as shown in FIG. 2 or 3, and used to correct an output current feedforward (e.g., output current sense) signal to account for input voltage changes.

It will also be appreciated that the above-described converter configurations are provided for purposes of illustration, and that many other converter configurations may be used in accordance with the present invention. In general, boost converter apparatus and methods according to embodiments of the present invention may be implemented using analog circuitry, digital circuitry (e.g., microprocessors or microcontrollers), or combinations of analog and digital circuitry. It will also be understood that embodiments of the invention include, but are not limited to, boost converters, control circuits configured to control boost converters, and methods of operating boost converters. Thus, for example, embodiments of the present invention may include, for example, boost converters including inductors, rectifiers, boost switches and control circuitry thereof. Embodiments of the invention may also include integrated circuits configured to control such components and/or combinations of discrete electronic components that provide similar control functionality. For example, a boost converter controller according to some embodiments of the present invention may include integrated circuits, circuits with discrete components or combinations thereof that receive current sense signals and control a boost converter switch along the lines described above.

It will be further understood that embodiments of the present invention may be advantageously used in a variety of different applications. For example, although embodiments of the present invention may be used to achieve power factor correction in boost converters having an AC input, other embodiments may find advantageous application in DC-DC converter and other applications.

FIGS. 1-8 illustrate architecture, functionality, and operations of possible implementations of apparatus and methods according to various embodiments of the present invention. It should be noted that, in some embodiments of the present invention, components may be arranged differently than shown in the figures and/or acts may occur in an order different than that shown in the figures. For example, two blocks shown in succession may, in fact, be executed substantially concurrently, or the blocks may sometimes be executed in the reverse order, depending upon the functionality involved.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A controller for a boost converter including an input inductor and a boost switch that control current conduction therefrom, the controller comprising:
a first current sense input configured to receive an inductor current sense signal representative of a current in the inductor;
a second current sense input configured to receive an output current sense signal representative of an output current of the boost converter; and
a control circuit configured to be coupled to the boost switch and to control the boost switch responsive to the received inductor current sense signal and the received output current sense signal to force an input current of the boost converter directly proportional to the output current and to an input voltage of the boost converter and inversely proportional to an output voltage of the boost converter.

2. The controller of claim 1, wherein the control circuit uses current feedforward from the output current sense signal.

3. The controller of claim 1, wherein the control circuit is configured to provide open loop regulation of the output voltage with respect to the output current.

4. The controller of claim 1, further comprising a voltage sense input configured to receive an output voltage sense signal representative of the output voltage, and wherein the control circuit is further configured to control the boost switch responsive to the output voltage sense signal.

5. The controller of claim 4, wherein the control circuit is configured to generate a correction signal responsive to a comparison of the output voltage sense signal to a reference signal, and wherein the control circuit is configured to control the boost switch responsive to a product of the inductor current sense signal and the correction signal.

6. The controller of claim 4, wherein control circuit comprises:
an error amplifier configured to generate an output voltage error signal representing a difference between the output voltage sense signal and a reference signal;
a multiplier configured to multiply the inductor current sense signal by the output voltage error signal to produce an output-voltage-corrected inductor current sense signal; and
a pulse width modulation (PWM) circuit configured to control a duty cycle of the boost switch responsive to the output current sense signal and the output-voltage-corrected inductor current sense signal.

7. The controller of claim 4, wherein the control circuit is configured to generate a correction signal responsive to a comparison of the output voltage sense signal to a reference signal, and wherein the control circuit is configured to control the boost switch responsive to a product of the output current sense signal and the correction signal.

8. The controller of claim 4, wherein control circuit comprises:
an error amplifier configured to generate an output voltage error signal representing a difference between the output voltage sense signal and a reference signal;
a multiplier configured to multiply the output current sense signal by the output voltage error signal to produce an output-voltage-corrected output current sense signal; and
a pulse width modulation (PWM) circuit configured to control a duty cycle of the boost switch responsive to the inductor current sense signal and the output-voltage-corrected output current sense signal.

9. The controller of claim 1, wherein the control circuit comprises a pulse-width modulation (PWM) circuit configured to control a duty cycle of the boost switch responsive to the inductor current sense signal and the output current sense signal.

10. The controller of claim 9, wherein the PWM circuit comprises a peak current mode control circuit, a valley current mode control circuit and/or a charge control circuit.

11. The controller of claim 9, wherein the PWM circuit comprises:
a drive circuit that initiates conduction by the boost switch responsive to a clock signal and terminates conduction by the boost switch responsive to a comparator output signal;
an integrator that periodically integrates the output current sense signal responsive to the clock signal to generate a sawtooth signal; and
a comparator that compares a difference between the output current sense signal and the sawtooth signal to the inductor current sense signal to generate the comparator output signal.

12. The controller of claim 9, wherein the PWM circuit comprises:
a drive circuit that initiates conduction by the boost switch responsive to a clock signal and terminates conduction by the boost switch responsive to a comparator output signal;
an integrator that periodically integrates the output current sense signal responsive to the clock signal to generate a sawtooth signal; and
a comparator that compares a sum of the inductor current sense signal and the sawtooth signal to the output current sense signal to generate the comparator output signal.

13. The controller of claim 9, wherein the PWM circuit comprises:
a drive circuit that initiates conduction by the boost switch responsive to a comparator output signal and terminates conduction by the boost switch responsive to a clock signal;
an integrator that periodically integrates the output current sense signal responsive to the clock signal to generate a sawtooth signal; and
a comparator that compares the sawtooth signal to the inductor current sense signal to generate the comparator output signal.

14. The controller of claim 9, wherein the PWM circuit comprises:
a drive circuit that initiates conduction by the boost switch responsive to a comparator output signal and terminates conduction by the boost switch responsive to a clock signal;
an integrator that periodically integrates a sum of the output current sense signal and a stabilizing signal responsive to the clock signal to generate a sawtooth signal; and
a comparator that compares the sawtooth signal to a sum of the inductor current sense signal and the stabilizing signal to generate the comparator output signal.

15. The controller of claim 9, further comprising:
a voltage sense input configured to receive an output voltage sense signal representative of the output voltage;
an error amplifier configured to generate an output voltage error signal representing a difference between the output voltage sense signal and a reference signal;
a multiplier configured to multiply the output current sense signal or the inductor current sense signal by the output voltage error signal to produce an output-voltage-corrected output current sense signal or an output-voltage-corrected inductor current sense signal; and
wherein the PWM circuit is configured to control the duty cycle of the boost switch responsive to the output-voltage-corrected output current signal or the output-voltage-corrected inductor current sense signal.

16. The controller of claim 1, wherein the control circuit is configured to control the input current without sensing the input voltage.

17. The controller of claim 1, wherein the first current sense input, the second current sense input and the control circuit are implemented in an integrated circuit and are configured to be coupled to an inductor current sensor, and output current sensor and the boost switch, respectively.

18. A boost converter, comprising:
an input;
an output;
an inductor coupled to the input;
a rectifier coupled to the inductor and the output;
a boost switch that controls conduction from the inductor through the rectifier;
an inductor current sensor configured to generate an inductor current sense signal representative of a current in the inductor;
an output current sensor configured to generate an output current sense signal representative of an output current at the output; and
a control circuit configured to control the boost switch responsive to the inductor current sense signal and the output current sense signal to force an input current at the input directly proportional to the output current and to an input voltage at the input and inversely proportional to an output voltage at the output.

19. The converter of claim 18, wherein the control circuit uses current feedforward from the output current sense signal.

20. The converter of claim 18, wherein the control circuit is configured to provide open loop regulation of the output voltage with respect to the output current.

21. The converter of claim 18, further comprising a voltage sense input configured to receive an output voltage sense signal representative of the output voltage, and wherein the control circuit is further configured to control the boost switch responsive to the output voltage sense signal.

22. The converter of claim 18, wherein the control circuit comprises a pulse-width modulation (PWM) circuit configured to control a duty cycle of the boost switch responsive to the inductor current sense signal and the output current sense signal.

23. The converter of claim 20, wherein the PWM circuit comprises a peak current mode control circuit, a valley current mode control circuit and/or a charge control circuit.

24. The converter of claim 18, wherein the control circuit is configured to control the input current without sensing the input voltage.

25. The converter of claim 18, further comprising a voltage sense input configured to receive an output voltage sense signal representative of the output voltage, and wherein the control circuit is further configured to control the boost switch responsive to the output voltage sense signal.

26. The converter of claim 18, further comprising a filter configured to filter the inductor current sense signal, and wherein the control circuit is configured to control the boost switch responsive to the filtered inductor current sense signal.

27. A method of operating a boost converter including an input inductor and boost switch that controls current conduction therefrom, the method comprising:
generating an inductor current sense signal representative of a current in the inductor;
generating an output current sense signal representative of an output current of the boost converter; and
controlling the boost switch responsive to the inductor current sense signal and the output current sense signal to force the input current directly proportional to the output current and to an input voltage of the boost converter and inversely proportional to an output voltage of the boost converter.

28. The method of claim 27, wherein controlling a boost switch of the converter responsive to the inductor current sense signal and the output current sense signal comprises using current feedforward from the output current sense signal.

29. The method of claim 27, wherein controlling a boost switch of the converter responsive to the inductor current sense signal and the output current sense signal comprises providing open loop regulation of the output voltage with respect to the output current.

30. The method of claim 27, wherein controlling a boost switch of the converter responsive to the inductor current sense signal and the output current sense signal comprises controlling the input current without sensing the input voltage.

31. The method of claim 27, further comprising generating an output voltage sense signal representative of the output voltage, and wherein controlling a boost switch of the converter responsive to the inductor current sense signal and the output current sense signal comprises controlling the boost switch responsive to the output voltage sense signal.

32. The method of claim 27, further comprising filtering the inductor current sense signal, and wherein controlling the boost switch responsive to the inductor current sense signal and the output current sense signal comprises controlling the boost switch responsive to the filtered inductor current sense signal.
